(19) United States
(12) Patent Application Publication
(10) Pub. No.: US 2001/0026823 A1
(43) Pub. Date: Oct. 4, 2001

(54) Process for the production of precooked cornmeal

(75) Inventors: Marco Pellegrini, Erba (CO) (IT); Carlo Stucchi, Milano (IT)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Bonomelli S.r.1.

(21) Appl. No.: 09/825,553

(22) Filed: Apr. 3, 2001

(30) Foreign Application Priority Data
Apr. 3, 2000 (IT) MI2000A000703

(51) Int. Cl. A21D 2/00

(52) U.S. Cl. 426/461; 426/507; 426/463

(57) ABSTRACT

The present invention relates to a continuous process for the production of precooked cornmeal comprising the subsequent sieving (2), precooking (4, 6) and particle size selecting (9) steps. Before the precooking (4, 6) the cornmeal is divided into two portions, wherein the first portion is subjected to precooking (4) in the presence of water vapor whereas the second portion is subjected to precooking (6) in the presence of water vapor and hot water. Said first and second portion are brought together before said particle size selecting step (9). The precooked cornmeal obtained by the process according to the present invention is suitable for the preparation of a food product which reproduces at best all the features of the home-made polenta.

The present invention relates to the industrial processes for the production of precooked food preparations, and particularly it relates to a continuous process for the preparation of precooked cornmeal.

The cornmeal polenta is traditionally prepared by a home-made process which requires cooking for about 40 minutes and continuous stirring of the mixture formed of cornmeal and hot water. The resulting known product is a homogeneous mixture having rough consistency, intense yellow color and a typical “toasted” taste.

Some industrial processes for the production of precooked cornmeal, suitable for considerably reducing the preparation time of the polenta are known, which use a single cooker wherein cornmeal is moistened and heated until it reaches the desired precooking degree.

However, the final product which can be obtained from these precooked cornmeals does not have the above mentioned qualities, particularly of the organoleptic kind, which are typical of the traditionally prepared polenta. It is instead a non-homogeneous mixture, wherein hard granules can be distinguished inside a fluid mass, having pale yellow color and without the typical toasted taste.

Object of the present invention is therefore providing a process for the production of precooked cornmeal free from said drawbacks. Said object is achieved by a continuous process whose main features are specified in the first claim and other features are specified in the following claims.

A first advantage of the process according to the present invention consists in that the precooked cornmeal obtained by said process is suitable for the preparation of a food product which reproduces at best all the features of the home-made polenta.

Another advantage of the process according to the present invention consists in that it allows a considerable flexibility in the management of the working parameters thereof, and it is therefore possible to modulate automatically said parameters in order to obtain a final product having the desired features, always constant and independent from the starting material.

Further advantages and features of the process according to the present invention will appear to those skilled in the art from the following detailed description with reference to the only drawing, wherein:

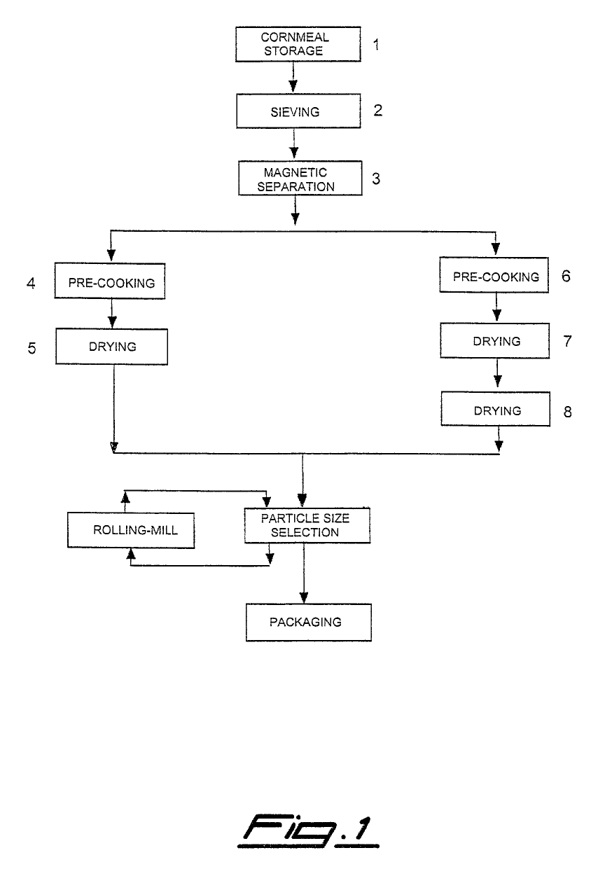

FIG. 1 shows a block diagram of the continuous process for the production of precooked cornmeal according to said embodiment of the present invention.

As it is shown in the drawing, the cornmeal from the storage silos 1 is first subjected to sieving 2 in order to eliminate possible foreign substances, and subsequently to a magnetic separation 3, during which the cornmeal is passed through a magnetic field for removing the ferrous material. After said steps, the cornmeal is divided into two portions which undergo the precooking steps 4 and 6, different from each other. The first portion of cornmeal is less than half of the total quantity of cornmeal; preferably said portion is between ¼ and ½ of the total cornmeal. Each portion is then introduced in a stainless steel cooker which is internally provided with means for stirring the cornmeal. Said means can be formed for example of horizontal rods fixed to a rotating shaft. The cookers can be externally provided with a heating jacket, in the interspace of which, for example, low pressure vapor is circulated, or they can be insulated.

The precooking step 4 of the first portion of cornmeal is carried out at a temperature varying between 40 and 70° C., according to the features of the cornmeal which is used. Through a multiplicity of nozzles, water vapor is introduced into the cooker in a weight quantity comprised between 10 and 20% of the cornmeal. The quantity of vapor which is used can be determined according to the desired humidification degree of the cornmeal. During said step the first portion of cornmeal undergoes a partial precooking. Subsequently, the drying step 5 is carried out, which causes the starches expansion and further confers to the cornmeal the typical “toasted” taste; it consists in sucking the cornmeal at the cooker outlet in an air flow having a temperature between 270° and 320° C.

The second portion of the cornmeal is subjected to a more energetic precooking step 6, which is carried out at a temperature between 70 and 100° C. and in the presence of a quantity of water vapor between 15 and 25% by weight of the cornmeal. In addition to the vapor, hot water is introduced into the cooker in a quantity between 10 and 20% by weight of the cornmeal. After a drying step 7, carried out similarly to step 5, said second portion of cornmeal is introduced into an oven, for example of the rotating or fluid bed type, wherein a further drying step 8 is carried out.

At this point, said first and second portion of the cornmeal are brought together and subjected again to the particle size selecting step 9. After said selecting step, the fraction of cornmeal having the desired particle size can be forwarded to the packaging step 11, whereas that with higher particle size has to be further treated in a rolling-mill before being mixed again.

Further variations and/or additions can be made by those which are skilled in the art to the described and illustrated embodiment while remaining within the scope of the invention itself.

1. A continuous process for the production of precooked cornmeal comprising the subsequent sieving (2), precooking (4, 6) and particle size selecting (9) steps, characterized in that before the precooking (4, 6), the cornmeal is divided into two portions, the first portion being smaller than the second and being subjected to precooking (6) in the presence of water vapor and hot water.

2. A process according to claim 1, characterized in that said first portion of cornmeal is greater than ¼ of the total quantity of cornmeal.

3. A process according to claim 2, characterized in that the precooking (4) of said first portion of cornmeal is carried out in the presence of a quantity of water vapor comprised between 10 and 20% by weight of the cornmeal and that the precooking (6) of said second portion of cornmeal is carried out in the presence of a quantity of water vapor comprised between 15 and 25% by weight of the cornmeal and of a quantity of hot water comprised between 10 and 20% by weight of the cornmeal.

4. A process according to claim 2, characterized in that the precooking (4) of said first portion of cornmeal comprises heating at a temperature between 40 and 70° C. and that the precooking (6) of said second portion of cornmeal comprises heating at a temperature between 70 and 100° C.

5. A process according to claim 2, characterized in that, after said precooking steps (4, 6) said first portion and said second portion of cornmeal are separately subjected to drying steps (5, 7) with air flows whose temperature is between 270 and 320° C.

6. A process according to the preceding claim, characterized in that after said drying step (7), the second portion of the cornmeal is subjected to a further drying step (8).

7. A process according to the preceding claim, characterized in that after said drying steps (5, 8) the first portion and the second portion of the cornmeal, brought together, are subjected to said particle size selecting step (9).

8. A process according to one or more of the preceding claims, characterized in that after said particle size selecting step (9) the fraction having the larger particle size is treated in a rolling-mill (10) and then brought together with the rest of the cornmeal.
